(19) United States
(12) Patent Application Publication
(10) Pub. No.: US 2009/0026419 A1
(43) Pub. Date: Jan. 29, 2009

(54) Partial oxidation of hydrocarbons

(76) Inventor: Bang-Cheng Xu, Houston, TX (US)

Correspondence Address: PAI PATENT & TRADEMARK LAW FIRM, 1001 FOURTH AVENUE, SUITE 3200, SEATTLE, WA, 98154, US

(21) Appl. No.: 11/880,514

(22) Filed: Jul. 23, 2007

(51) Int. Cl. C01B 3/38

(52) U.S. Cl. 252/373

(57) ABSTRACT

A process of catalytic partial oxidation of hydrocarbons, particularly methane and/or natural gas to form a product containing hydrogen and carbon monoxide where the first catalyst at the inlet has a lower surface area than that of a second catalyst closer to the outlet.

### FIELD OF THE INVENTION

The present invention generally relates to catalytic partial oxidations of hydrocarbons to produce a product mixture comprising hydrogen and carbon monoxide.

### BACKGROUND OF THE INVENTION

Oil production is quickly reaching its peak and it is expected that natural gas will increasingly become the starting material of choice for energy production and/or feedstock for industrial chemical processes. Usually natural gas, which comprises mostly methane, is converted to synthesis gas (used hereinafter interchangeably as “syngas”) first. Syngas generally refers to a mixture of carbon monoxide and hydrogen. Syngas then is converted to different products in subsequent reaction or reactions.

Steam reforming has been the most commonly practiced commercial process for making syngas in the natural gas industry for many years. This reforming reaction is highly endothermic and requires heat input. The resultant of 3:1 H₂ to CO molar ratio syngas is not ideally suitable for methanol synthesis or Fischer-Tropsch reactions producing various hydrocarbon liquids. A stoichiometric equation of steam reforming of methane is shown below as equation (I):

CH₄+H₂O≡CO+3H₂ (I)

On the other hand, a partial oxidation reaction of methane is mildly exothermic (ΔH°₂₉₈=−8.5 kcal). The resultant of 2:1 H₂ to CO molar ratio syngas according to the equation (II) below produces the ideal stoichiometry for methanol synthesis or Fischer-Tropsch reactions.

CH₄+0.5O₂≡CO+2H₂ (II)

The research on light hydrocarbon such as methane catalytic partial oxidation to make syngas has drawn greater attention since the early 1990s. Precious metals supported on porous ceramic monoliths or particulate solids as carriers are widely used as catalysts for carrying out such a partial oxidation reaction. In addition to the desired partial oxidation reaction, there are many side reactions. One of them is complete oxidation of methane as shown below. The complete oxidation reaction of methane or other hydrocarbons is much more exothermic than the desired partial oxidation reaction, thus releasing more heat.

CH₄+2O₂≡2H₂O+CO₂ (III)

There are always some amounts of the byproducts H₂O and CO₂ along with the desired partial oxidation products H₂ and CO. Since there is also some un-reacted CH₄ in the product stream, certain reforming reactions such as (IV) and (V) below are a possible side reactions in the reactor.

CH₄+H₂O ≡CO+3H₂ (IV)

CH₄+CO₂≡2CO+2H₂ (V)

Because of the existence of the more exothermic complete methane (or other hydrocarbons) oxidation reaction, a high temperature hot area/zone is formed at top or front of the catalyst bed. It is commonly observed that the temperature rise in the hot area/zone is much higher than the partial oxidation adiabatic temperature as predicted by calculations or modeling. The high temperature rise may cause damages to the catalyst as the rate of catalyst deactivation increases with temperature. After the top layer catalyst is deactivated, the hot area/zone moves down along the catalyst bed. Consequently, it is typically observed in an experiment that the reaction system outlet temperature increases and the conversion and selectivity decrease with time.

Experiments show that to reduce the catalyst surface area by loading higher amount of metal could increase catalyst life. When more metal is loaded on the carrier, while catalyst life can be increased, the reaction reaches a point where both the hydrocarbon conversion and H2 and CO selectivity are reduced. To increase the catalyst life without affecting conversion and selectivity, a second layer of higher surface area catalyst with lower metal loading is added second to the above catalyst. Experiments show that catalyst conversion and selectivity reach the same level as the original higher surface area catalyst without decreasing catalyst life.

On the other hand, the reforming reactions are strongly endothermic. As a result, the temperature along the catalyst bed in a reactor or reaction system decreases rather quickly and requires heat or thermal input to maintain the reaction rate. At high temperatures, the reforming reactions are very fast. The reforming reaction even can be very fast in gas phase without catalyst. But at low temperatures, the reforming slows down substantially. According to examples in patent application WO0132556, 90% to 95% of the oxygen is consumed in a very thin reaction zone in the front, less than three particle diameters from the catalyst bed inlet. The particle size in the above patent example is in the range of 192 to 450 microns and the catalyst bed length is 10 mm. For a length of only three particles, the depth of the catalyst bed used for oxidation is only a small potion of the entire catalyst bed. Therefore, only reforming reactions take place in the rest of the catalyst bed.

It is therefore desirable to have a catalytic partial oxidation reaction process which can (a) reduce the initial complete oxidation of hydrocarbon feed, such as methane, and/or natural gas and/or other organic compound mixtures to reduce the temperature rise in the front of the reactor or reaction system and at the same time and/or (b) maintain as high as possible a temperature in the rest of the reactor or reaction system in order to maintain a reasonable reaction rate for reforming reactions to convert undesirable complete oxidation products

### SUMMARY OF THE INVENTION

The present invention relates to a catalytic partial oxidation process which comprises passing a feed stream through at least a first reaction zone and subsequently a second reaction zone, wherein the first reaction zone containing a first catalyst, the first catalyst comprises at least one first metal having a first surface area, the first catalyst comprises a first metal supported on a low surface area carrier; and the second reaction zone containing a second catalyst having a second surface area, the second catalyst comprises a second metal supported on a high surface area carrier to produce an effluent stream comprising carbon monoxide and hydrogen; wherein the feed stream comprises (a) a hydrocarbon feedstock, and (b) oxygen or an oxygen containing mixture; wherein the first surface area of the first catalyst is lower than the second surface area of the second catalyst.

Another embodiment of the present invention relates to a catalytic partial oxidation process wherein the first metal of the first catalyst is selected from the group consisting of iron, cobalt, nickel, ruthenium, rhodium, palladium, osmium, iridium, platinum, titanium, vanadium, chromium, molybdenum, tungsten, alloys thereof, and mixtures thereof; and wherein the first metal is in a form selected from the group consisting of reduced forms of one or more metals, oxidized forms of one or more metals, one or more alloys, and mixtures thereof; and/or the second metal is selected from the group consisting of iron, cobalt, nickel, ruthenium, rhodium, palladium, osmium, iridium, platinum, and mixtures thereof; and/or the second catalyst further comprises a promoter metal selected from the group consisting of lanthanum, cerium, gadolinium, praseodymium, neodymium, dysprosium, holmium, ytterbium, samarium europium, erbium, terbium, lutetium, thorium, uranium, and mixtures thereof.

Another embodiment of the present is that the conversion of a hydrocarbon, including but not limited to methane, in a process according to the instant invention is at least 50%, preferably at least about 60%, more preferably at least about 70%, and most preferably at least 75%.

Another aspect of the present invention involves a catalytic system wherein the space velocity for the two catalysts is in the range of from about 10,000 to about 10,000,000 NL/kg/h, preferably from about 50,000 to about 1,000,000 NL/kg/h.

A further aspect of the present invention wherein both the low surface area carrier and the high surface area carrier are selected from the group consisting of one or more refractory metal oxides, one or more rare earth modified refractory metal oxides, one or more alkaline earth metal modified refractory metal oxides, and mixtures thereof; and/or both the low surface area carrier and the high surface area carrier is selected from the shape of sphere, pellet, trilobe, particulate, bead, ring, granule, and mixtures thereof; and/or the metal of the carrier is selected from the group consisting of oxides of aluminum, zirconium, magnesium, titanium, silicon, lanthanum, cerium, gadolinium, praseodymium, neodymium, dysprosium, holmium, ytterbium, samarium europium, erbium, terbium, lutetium, thorium, uranium, and mixtures thereof.

Another embodiment of the present invention relates to the catalytic partial oxidation process wherein the low surface area carrier comprises a support with the pores filled with a suitable amount of a filler metal to reach the surface area of less than about 1.0 square meter per gram (m²/g).

Yet another aspect of the present invention relates to a catalytic partial oxidation process, said process passing a feed stream through at least a first reaction zone and subsequently a second reaction zone, wherein the first reaction zone containing a first catalyst, the first catalyst comprises at least one first metal having a first surface area; and the second reaction zone containing a second catalyst having a second surface area, the second catalyst comprises a second metal supported on a high surface area carrier to produce an effluent stream comprising carbon monoxide and hydrogen; wherein the feed stream comprises (a) a hydrocarbon feedstock, and (b) oxygen or an oxygen containing mixture; wherein the first surface area of the first catalyst is lower than the second surface area of the second catalyst; and the first metal of the first catalyst is selected from the group consisting of iron, cobalt, nickel, ruthenium, rhodium, palladium, osmium, iridium, platinum, titanium, vanadium, chromium, molybdenum, tungsten, alloys thereof, and mixtures thereof and wherein the first metal is in a form selected from the group consisting of reduced forms of one or more metals, oxidized forms of one or more metals, one or more metal alloys, and mixtures thereof; the second metal is selected from the group consisting of iron, cobalt, nickel, ruthenium, rhodium, palladium, osmium, iridium, platinum, and mixtures thereof, both the low surface area carrier and the high surface area carriers are selected from the group consisting of one or more refractory metal oxides, one or more rare earth modified refractory metal oxides, one or more alkaline earth metal modified refractory metal oxides, and mixtures thereof; both low surface area carrier and the high surface area carriers are selected from the shape of sphere, pellet, trilobe, particulate, bead, ring, granule, and mixtures thereof; the promoter metal for the second catalyst is selected from the group consisting of lanthanum, cerium, gadolinium, praseodymium, neodymium, dysprosium, holmium, ytterbium, samarium europium, erbium, terbium, lutetium, thorium, uranium, and mixtures thereof; the space velocity is in the range of from about 10,000 to about 10,000,000 NL/kg/h; the inlet temperature is in the range of from about 250° C. to about 450° C.; the pressure is in the range of from about 101 kPa to about 3,500 kPa; atomic ratio of carbon of the feed stream to oxygen is in the range of from about 1.3:1 to 3.3:1, preferably 1.8:1 to about 2.2:1.

It is yet another embodiment of the present invention that a catalytic partial oxidation process comprises passing a feed stream through at least a first reaction zone and subsequently a second reaction zone, wherein the first reaction zone containing a first catalyst, the first catalyst comprises (A) at least one first metal having a first surface area; or (B) a mixture of (A) and at least one third metal on at least one low surface area carrier with a low surface area less than about 1.0 square meter per gram (m²/g); and the second reaction zone containing a second catalyst having a second surface area, the second catalyst comprises a second metal supported on a high surface area carrier to produce an effluent stream comprising carbon monoxide and hydrogen; wherein the feed stream comprises (a) a hydrocarbon feedstock, and (b) oxygen or an oxygen containing mixture; wherein the first surface area of the first catalyst is lower than the second surface area of the second catalyst; and the first metal of the first catalyst is selected from the group consisting of iron, cobalt, nickel, ruthenium, rhodium, palladium, osmium, iridium, platinum, titanium, vanadium, chromium, molybdenum, tungsten, alloys thereof, and mixtures thereof and wherein the first metal is in a form selected from the group consisting of reduced forms of one or more metals, oxidized forms of one or more metals, one or more metal alloys, and mixtures thereof; the second metal is selected from the group consisting of iron, cobalt, nickel, ruthenium, rhodium, palladium, osmium, iridium, platinum, lanthanum, cerium, gadolinium, praseodymium, neodymium, dysprosium, holmium, ytterbium, samarium europium, erbium, terbium, lutetium, thorium, uranium, and mixtures thereof, both the low surface area carrier and the high surface area carriers are selected from the group consisting of one or more refractory metal oxides, one or more rare earth modified refractory metal oxides, one or more alkaline earth metal modified refractory metal oxides, and mixtures thereof, both the low surface area carrier and the high surface area carriers are selected from the shape of sphere, pellet, trilobe, particulate, bead, ring, granule, and mixtures thereof; a promoter metal for second catalyst is selected from the group consisting of lanthanum, cerium, gadolinium, praseodymium, neodymium, dysprosium, holmium, ytterbium, samarium europium, erbium, terbium, lutetium, thorium, uranium, and mixtures thereof; the space velocity is in the range of from about 10,000 to about 10,000,000 NL/kg/h; the inlet temperature is in the range of from about 15° C. to about 750° C., preferably 250° C. to about 450° C.; the pressure is in the range of from about 101 kPa to about 3,500 kPa; atomic ratio of carbon of the feed stream to oxygen is in the range of from about 1.3:1 to 3.3:1, preferably about 1.8:1 to about 2.2:1.

### BRIEF DESCRIPTION OF THE DRAWING

FIG. 1 is a schematic drawing of a catalytic reactor made of stainless steel suitable for laboratory scale tests of the catalysts of the preferred combination. The lower surface area catalyst is used at the catalyst top as the first metal catalyst. The first high surface area carrier supported porous catalyst is followed with the second low surface area catalyst to give large reaction surface.

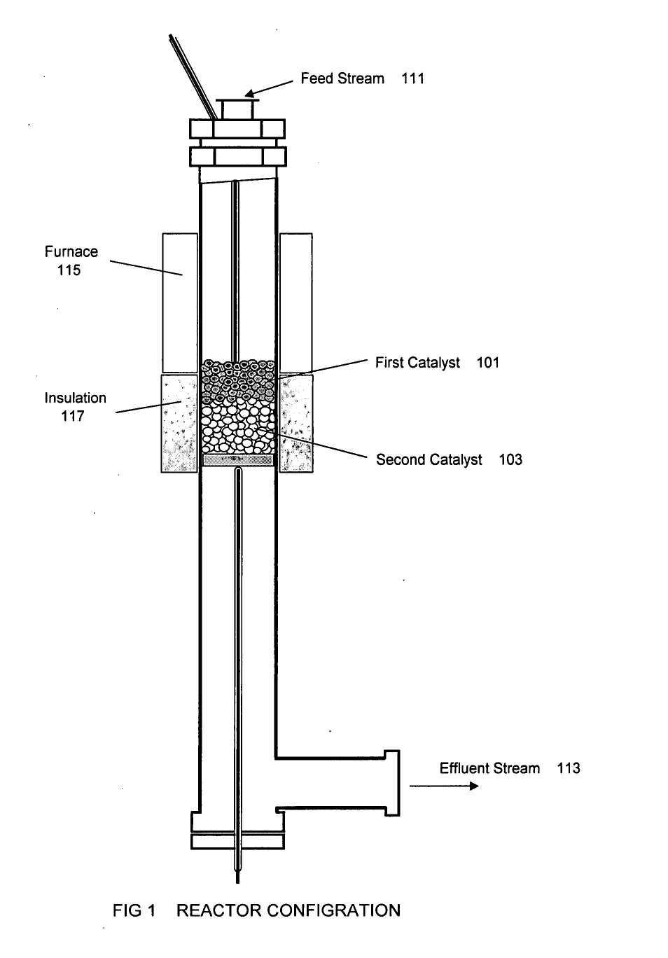

### DETAILS OF THE INVENTION

From analytical and experimental results in converting hydrocarbons to syngas, partial oxidation reactions and other high exothermic undesirable side oxidation reactions to form H₂O and CO₂ appear to happen at or near the top (inlet) of catalyst bed while reforming reactions take place later, following these oxidation reactions. Thus, it is desirable that there be at least two reactors or two catalyst beds. The first reaction zone contains a first catalyst, which comprises a first material in a certain shape to be discussed in more detail later herein.

The first catalyst catalyzes primarily hydrocarbon oxidation reactions and possibly a small part of the reforming reaction at a high temperature. The second reactor with metal on porous carrier to carry out the reforming reaction is typically operated at a lower temperature. As discussed in more detail later, the two reactors and/or catalyst beds can be separated or can be put in the same vessel with or without distance or other materials/substances, inert or otherwise, in between.

The first metal and/or the third metal, if any, of the first catalyst may be the same or different. They may also be mixtures of various metals described herein.

It is within the scope of the present invention that there are various inventive ways to improve the porous carrier catalyst the first material comprises at least one first metal supported on at least one low surface area carrier with a first surface area less than about 1.0 square meter per gram (m²/g). For example, the catalyst on the top of the catalyst bed could be loaded with a large amount of metal to fill the pore, since the internal surface is not useful at the top and the heat conductivity could be increased with the pore full of metal. The metal fill amount in the catalyst could be reduced along the catalyst bed to increase the internal surface for the slower reforming reaction down the catalyst bed.

The first catalyst used in the first bed for partial/complete hydrocarbon oxidation reaction is preferably a metal, such as one or more precious metals. They can also be such metals mixed with the same or a different metal supported on a low-surface area carrier with a first surface area less than about 1.0 square meter per gram (m²/g).

If a lower surface area support is used for the first catalyst, the result is similar to that of using metal to fill out the pore in the carrier. Also, the low surface area carrier comprises a support with the pores filled with a suitable amount of a filler metal to reach a desirable surface area of less than about 1.0 square meter per gram (m²/g).

As discussed, many metals are suitable for the present invention as the first metal and/or the third metal for the first catalyst. For the present invention, a suitable first metal and/or third of the first catalyst is selected from the group consisting of iron, cobalt, nickel, ruthenium, rhodium, palladium, osmium, iridium, platinum, titanium, vanadium, chromium, molybdenum, tungsten, alloys thereof, and mixtures thereof. A preferred first metal is selected from the group consisting of nickel, ruthenium, rhodium, palladium, iridium, tungsten, alloys thereof, and mixtures thereof.

In addition, the first metal and/or the third metal of the first catalyst can be present in various forms—metallic state, reduced forms, oxidized forms, hydrides, sulfides, alloys, complexes, and mixtures thereof.

Some examples of a second metal in the second reaction zone suitable for the present invention are selected from, but are not limited to, the group consisting of iron, cobalt, nickel, ruthenium, rhodium, palladium, osmium, iridium, platinum, lanthanides such as lanthanum, cerium, gadolinium, praseodymium, neodymium, dysprosium, holmium, ytterbium, samarium europium, erbium, terbium, lutetium, actinides such as thorium, uranium, and mixtures thereof. Preferred second metal includes, but is not limited to cobalt, nickel, ruthenium, rhodium, palladium, osmium, iridium, platinum.

Carriers suitable for the second catalyst of the present invention include, but are not limited to those compounds with high surface areas, particularly high internal surface areas. Preferred carriers include, but are not limited to one or more refractory metal oxides, one or more rare earth metal modified refractory metal oxides, one or more alkaline earth metal modified refractory metal oxides, and mixtures thereof Examples of such metals for these metal oxides are selected from the group consisting of beryllium, magnesium, calcium, strontium, barium, boron, aluminum, zirconium, titanium, silicon, lanthanum, cerium, gadolinium, praseodymium, neodymium, dysprosium, holmium, ytterbium, samarium europium, erbium, terbium, lutetium, thorium, uranium, and mixtures thereof.

The high surface area carrier of the second catalyst has a substantially stable surface area under reaction conditions. The term “substantially stable” within this invention means that the loss of surface area under prevailing reaction conditions over time is less than 2% per hour.

The feed stream comprises a mixture of a hydrocarbon feedstock and an oxidizing agent. The mixture can be made as a single feed; or alternatively, the hydrocarbon feedstock and the oxidizing agent can be mixed prior to being introduced into the reaction zone.

The hydrocarbon feedstock can be selected from various compounds such as C₁ to C₁₀ organic compounds, including, but not limited to methane, ethane, propane, butanes, pentanes, hexanes, heptanes, octanes, nonanes, decanes, and mixtures thereof. Unsaturated hydrocarbons can be present, and/or used alone or in conjunction with saturated hydrocarbons too. Examples include, but are not limited to ethylene, acetylene, propylene, propyne, allene, C₄ to C₁₀ unsaturated compounds such as butene-1, butyne-1, and others, and mixtures thereof. Other heteroatom-containing compounds can be present in the hydrocarbon feedstock too. Examples include, but are not limited to CO, CO₂, methanol, methylamine, formaldehyde, formic acid, ethanol, acetaldehyde, acetic acid, other similar oxygen or nitrogen containing compounds, and mixtures thereof. Heavier hydrocarbons can be present in the hydrocarbon feedstock too. But it is preferred that they are present in small quantities to avoid excessive catalyst deactivation.

Light hydrocarbons, C₁-C₅ saturated or unsaturated compounds and/or their mixtures are preferred. For the present invention, it is more preferred to use a hydrocarbon feedstock comprising methane, or ethane, or propane, or butanes, and/or mixtures thereof. So-called natural gas and liquefied natural gas also are more preferred. They comprise primarily methane, ethane, propane and some other hydrocarbons in small quantities. When single hydrocarbon is used, a feed consists essentially of methane is most preferred. As already stated, if there is a recycle of certain product streams in the catalytic partial oxidation process of the present invention, some oxygen-containing compounds such as CO, CO₂, methanol, formaldehyde, formic acid, and others may also be present. The amounts would depend on the proportion of the recycle stream relative to the fresh feed.

While many different oxidizing agents can be used, it is preferred to use oxygen, air, other compositions containing oxygen, and mixtures thereof. The concentration of oxygen in the total feed stream is in the range of from about 0.01 vol % to about 50 vol %, preferably from about 0.1 vol % to about 35 vol %. Depending on the hydrocarbon feedstock, it is preferred to use oxygen concentrations outside the so-called flammable region to minimize operational risks.

Furthermore, the carbon to oxygen ratios are from about 1:1 to about 3.3:1, more preferably, from about 1.3:1 to about 2.4:1, and most preferably from about 1.8:1 to 2.2:1.

As discussed, at least two different catalysts are used for the present invention to catalytically and partially oxidize the hydrocarbon feedstock to produce an effluent stream. The effluent stream comprises carbon monoxide and hydrogen. As already stated above and depending on the process conditions and feedstock compositions, there may be other by-products and/or co-products in the effluent stream, such as carbon dioxide, water, methanol, formaldehyde, formic acid, and others.

It is preferred that at least two catalysts are present in a reactor or a reaction system in series. There are many different ways to accomplish this arrangement for the present invention. One way is to have the catalyst stacked in the reactor, with or without any space or other materials or piping between the catalyst layers. The reactor can be placed vertically, horizontally, or in any other suitable angle, arrangements, or combinations thereof known to those skilled in the art. It is also within the scope of the present invention to have two or more catalysts (as a non-exclusive example) mixed to form a gradient—100% of the first catalyst in the front, decreasing amounts of the first catalyst and increasing of the second catalyst along the reactor and finally 100% of the second catalyst in the backend of the reactor.

The feed stream is initially contacted with a first catalyst in the front under selected and appropriate reaction conditions. The first catalyst comprises a material, which has a shape of porous foam, gauze, mesh, honeycomb, wheel, monolith, mixtures thereof and other suitable forms. The material itself may be made of a first metal. Or, this material is loaded with a first metal for the first catalyst.

The catalytic partial oxidation reaction can be carried out under a variety of reaction conditions. The conditions are selected and adjusted in accordance with the feed stream selected, the hydrocarbon selected, the oxidizing agent selected, the first catalyst selected, the second catalyst selected, other catalyst(s) selected, the manner in which the catalysts are configured, the reactor type, the desired synthesis gas composition (hydrogen to carbon monoxide ratio), whether any products or byproducts will be recycled, and others.

Generally, a flow rate, measured as space velocity, suitable for the present invention is in the range of from about 10,000 to about 10,000,000 NL/Kg/Hr (normal liters per kilograms of catalyst per hour), preferably from about 50,000 to about 1,000,000 NL/Kg/Hr, and more preferably from about 100,000 to about 500,000 NL/Kg/Hr. The flow rate can be adjusted to achieve the desired conversion, selectivity and catalyst life of the catalytic partial oxidation.

For the present invention, an inlet temperature in the range of from about 15° C. to about 750° C. is considered suitable. The range is preferred to be in the range of from about 150 to about 550° C., more preferably from about 200° C. to about 400° C.

It is found that the catalyst degrades faster when the reactor is operated under pressure. At the high-pressure condition, the reactant density is higher and the heat generation per unit (weight or volume or other suitable measurements) catalyst is also higher. The porous catalyst carrier with high heat resistance cannot sustain the severe conditions and the active first (or catalytic active) metal is sintered at a faster rate than the rate of sintering for a reaction operated at lower pressures.

The equilibrium conversion of the catalytic partial oxidation reaction changes with operating pressure. As a general rule, side reactions increase, hydrocarbon conversion, product selectivity, and catalyst life decreases as the pressure in the reactor increases. Pressure is in the range of from about 101 kPa to about 4000 kPa; preferably from about 600 kPa to about 3500 kPa; and more preferably from about 1200 kPa to about 2500 kPa. The pressure can be adjusted as the reaction proceeds to obtain the desired reaction results.

Another aspect of the current invention relates to fuel cell. Steam is introduced in to the reactor between the two catalyst beds to do water gas shifting reaction to convert CO in syngas to H₂.

The conversion of a hydrocarbon, such as methane, in a process according to the instant invention is at least 50%, preferably at least about 60%, more preferably at least about 70%, and most preferably at least 75%.

Selectivity to H₂ is preferred to be at least 65 mol %, more preferably at least about 75 mol %, most preferably at least 85 mol %; and selectivity to CO is preferred to be least 65 mol %, more preferably at least about 75 mol %, most preferably at least 85 mol %.

### EXAMAPLE 1

### Comparison

A 20 millimeter diameter and the first catalyst (5 millimeter thick with W 45 wt %, Ni 13.5 wt %, La 9.2 wt %, Pt 0.6 wt %) followed by second catalyst (12 millimeter thick with Ni 13.5 wt %, La 11.2 wt %, Pt 0.57 wt %). A feed stream containing 67 (v) % methane and 33 (v) % oxygen (The feed is in the flammability range. But with good mixer, there is no problem. The higher inlet temperature can get more reforming and thus higher CH4 conversion and CO and H2 selectivity. The problem for higher inlet temperature is easier to get pre-ignition before the mixed gas contacting the catalyst.) was passed through the reactor containing above catalyst at a space velocity of 129,600 liters per kilograms of catalyst per hour (NL/kg/h). Methane conversion 98.3%, CO selectivity 94.6%, H₂ selectivity 99.8%, inlet temperature 250° C., Outlet temperature 850° C.

### EXAMAPLE 2

### Comparison

A 20 millimeter diameter and the first catalyst (5 millimeter thick with W 45 wt %, Ni 13.5 wt %, La 9.2 wt %, Pt 0.6 wt %) followed by second catalyst (12 millimeter thick with Rh 3.8 wt %, La 12 wt %). A feed stream containing 67 (v) % methane and 33 (v) % oxygen was passed through the reactor containing above catalyst at a space velocity of 390,000 liters per kilograms of catalyst per hour (NL/kg/h). Methane conversion 96.7%, CO selectivity 95.8%, H₂ selectivity 97.6%, inlet temperature 250° C., Outlet temperature 840° C.

The examples described above are for illustration purposes only. It is not intended, and should not be interpreted, to limit either the scope or the spirit of this invention. Those skilled in the art would appreciate that many other variations or substitutes can be used as equivalents for the purposes of this invention, which is defined solely by the written description and the claims.

I claim:

1. A catalytic partial oxidation process, said process comprises passing a feed stream through at least a first reaction zone and subsequently a second reaction zone, wherein
the first reaction zone containing a first catalyst, the first catalyst comprises at least one first metal having a first surface area, the first catalyst comprises a first metal supported on a low surface area carrier; and
the second reaction zone containing a second catalyst having a second surface area, the second catalyst comprises a second metal supported on a high surface area carrier to produce an effluent stream comprising carbon monoxide and hydrogen;
wherein the feed stream comprises (a) a hydrocarbon feedstock, and (b) oxygen or an oxygen containing mixture;
wherein the first surface area of the first catalyst is lower than the second surface area of the second catalyst.

2. The catalytic partial oxidation process of claim 1, wherein the first metal of the first catalyst is selected from the group consisting of iron, cobalt, nickel, ruthenium, rhodium, palladium, osmium, iridium, platinum, titanium, vanadium, chromium, molybdenum, tungsten, alloys thereof, and mixtures thereof; and wherein the first metal is in a form selected from the group consisting of reduced forms of one or more metals, oxidized forms of one or more metals, one or more alloys, and mixtures thereof.

3. The catalytic partial oxidation process of claim 1, wherein the low surface area carrier of the first metal of the first catalyst comprises one or more other metallic substances.

4. The catalytic partial oxidation process of claim 1, wherein the second metal is selected from the group consisting of iron, cobalt, nickel, ruthenium, rhodium, palladium, osmium, iridium, platinum, and mixtures thereof.

5. The catalytic partial oxidation process of claim 1, wherein the second catalyst further comprises a promoter metal selected from the group consisting of lanthanum, cerium, gadolinium, praseodymium, neodymium, dysprosium, holmium, ytterbium, samarium europium, erbium, terbium, lutetium, thorium, uranium, and mixtures thereof.

6. The catalytic partial oxidation process of claim 1, wherein the space velocity for the two catalysts is in the range of from about 50,000 to about 10,000,000 NL/kg/h.

7. The catalytic partial oxidation process of claim 1, wherein the low surface area carrier comprises a support less than about 1.0 square meter per gram (m²/g).

8. The catalytic partial oxidation process of claim 1, wherein the low surface area carrier comprises a support with the pores filled with a suitable amount of a filler metal to reach the surface area less than about 1.0 square meter per gram (m²/g).

9. The catalytic partial oxidation process of claim 1, wherein the high surface area carrier of the second catalyst has a substantially stable surface area under reaction conditions.

10. The catalytic partial oxidation process of claim 1, wherein both the low surface area carrier and the high surface area carriers are selected from the group consisting of one or more refractory metal oxides, one or more rare earth modified refractory metal oxides, one or more alkaline earth metal modified refractory metal oxides, and mixtures thereof.

11. The catalytic partial oxidation process of claim 10, wherein both the low surface area carrier and the high surface area carriers are selected from the shape of sphere, pellet, trilobe, particulate, bead, ring, granule, and mixtures thereof.

12. The catalytic partial oxidation process of claim 10, wherein both the low surface area carrier and the high surface area carriers are selected from the group consisting of oxides of aluminum, zirconium, magnesium, titanium, silicon, lanthanum, cerium, gadolinium, praseodymium, neodymium, dysprosium, holmium, ytterbium, samarium europium, erbium, terbium, lutetium, thorium, uranium, and mixtures thereof.

13. The catalytic partial oxidation process of claim 1, wherein the inlet temperature is in the range of from about 15° C. to about 750° C.

14. The catalytic partial oxidation process of claim 1, wherein the inlet temperature is in the range of from about 250° C. to about 450° C.

15. The catalytic partial oxidation process of claim 1, wherein the pressure in reactor is between about 101 kPa to 3,500 kPa.

16. The catalytic partial oxidation process of claim 1, wherein the atomic ratio of carbon of the feed stream to oxygen is in the range of from about 1.8:1 to about 2.2:1.

17. The catalytic partial oxidation process of claim 1, wherein the amount of the first metal of the first catalyst is in the range of from about 1 wt % to about 50 wt %;
the amount of the second metal of the second catalyst is in the range of from about 0.5 wt % to about 16 wt %; and
the second catalyst further comprises a promoter in the range of from about 2 wt % to about 20 wt %.

18. A catalytic partial oxidation process, said process comprises passing a feed stream through at least a first reaction zone and subsequently a second reaction zone, wherein
the first reaction zone containing a first catalyst, the first catalyst comprises at least one first metal having a first surface area; and
the second reaction zone containing a second catalyst having a second surface area, the second catalyst comprises a second metal supported on a high surface area carrier to produce an effluent stream comprising carbon monoxide and hydrogen;
wherein the feed stream comprises (a) a hydrocarbon feedstock, and (b) oxygen or an oxygen containing mixture;
wherein the first surface area of the first catalyst is lower than the second surface area of the second catalyst; and
the first metal of the first catalyst is selected from the group consisting of iron, cobalt, nickel, ruthenium, rhodium, palladium, osmium, iridium, platinum, titanium, vanadium, chromium, molybdenum, tungsten, alloys thereof, and mixtures thereof and wherein the first metal is in a form selected from the group consisting of reduced forms of one or more metals, oxidized forms of one or more metals, one or more metal alloys, and mixtures thereof;
the second metal is selected from the group consisting of iron, cobalt, nickel, ruthenium, rhodium, palladium, osmium, iridium, platinum, and mixtures thereof,
both the low surface area carrier and the high surface area carriers are selected from the group consisting of one or more refractory metal oxides, one or more rare earth modified refractory metal oxides, one or more alkaline earth metal modified refractory metal oxides, and mixtures thereof;
both low surface area carrier and the high surface area carriers are selected from the shape of sphere, pellet, trilobe, particulate, bead, ring, granule, and mixtures thereof;
the promoter metal for the second catalyst is selected from the group consisting of lanthanum, cerium, gadolinium, praseodymium, neodymium, dysprosium, holmium, ytterbium, samarium europium, erbium, terbium, lutetium, thorium, uranium, and mixtures thereof;
the space velocity is in the range of from about 50,000 to about 10,000,000 NL/kg/h;
the inlet temperature is in the range of from about 250° C. to about 450° C.;
the pressure is in the range of from about 101 kPa to about 3,500 kPa;
atomic ratio of carbon of the feed stream to oxygen is in the range of from about 1.8:1 to about 2.2:1.

19. A catalytic partial oxidation process, said process comprises passing a feed stream through at least a first reaction zone and subsequently a second reaction zone, wherein
the first reaction zone containing a first catalyst, the first catalyst comprises (A) at least one first metal having a first surface area; or (B) a mixture of (A) and at least one third metal on at least one low surface area carrier with a low surface area less than about 1.0 square meter per gram (m²/g); and
the second reaction zone containing a second catalyst having a second surface area, the second catalyst comprises a second metal supported on a high surface area carrier to produce an effluent stream comprising carbon monoxide and hydrogen;
wherein the feed stream comprises (a) a hydrocarbon feedstock, and (b) oxygen or an oxygen containing mixture;
wherein the first surface area of the first catalyst is lower than the second surface area of the second catalyst; and
the first metal of the first catalyst is selected from the group consisting of iron, cobalt, nickel, ruthenium, rhodium, palladium, osmium, iridium, platinum, titanium, vanadium, chromium, molybdenum, tungsten, alloys thereof, and mixtures thereof and wherein the first metal is in a form selected from the group consisting of reduced forms of one or more metals, oxidized forms of one or more metals, one or more metal alloys, and mixtures thereof;
the second metal is selected from the group consisting of iron, cobalt, nickel, ruthenium, rhodium, palladium, osmium, iridium, platinum, lanthanum, cerium, gadolinium, praseodymium, neodymium, dysprosium, holmium, ytterbium, samarium europium, erbium, terbium, lutetium, thorium, uranium, and mixtures thereof,
both the low surface area carrier and the high surface area carriers are selected from the group consisting of one or more refractory metal oxides, one or more rare earth modified refractory metal oxides, one or more alkaline earth metal modified refractory metal oxides, and mixtures thereof;
both the low surface area carrier and the high surface area carriers are selected from the shape of sphere, pellet, trilobe, particulate, bead, ring, granule, and mixtures thereof;
a promoter metal for second catalyst is selected from the group consisting of lanthanum, cerium, gadolinium, praseodymium, neodymium, dysprosium, holmium, ytterbium, samarium europium, erbium, terbium, lutetium, thorium, uranium, and mixtures thereof;
the space velocity is in the range of from about 50,000 to about 10,000,000 NL/kg/h;
the inlet temperature is in the range of from about 250° C. to about 450° C.;
the pressure is in the range of from about 101 kPa to about 3,500 kPa;
atomic ratio of carbon of the feed stream to oxygen is in the range of from about 1.8:1 to about 2.2:1.
